(19) United States
(12) Patent Application Publication
(10) Pub. No.: US 2023/0061745 A1
(43) Pub. Date: Mar. 2, 2023

(54) SUPPORT STAND

(71) Applicant: Chicony Electronics Co., Ltd., New Taipei City (TW)

(72) Inventors: Chung-Yao LIN, New Taipei City (TW); Chun-Cheng CHENG, New Taipei City (TW)

(21) Appl. No.: 17/811,304

(22) Filed: Jul. 7, 2022

(30) Foreign Application Priority Data
Sep. 2, 2021 (TW) 110132705

(51) Int. Cl. F16M 11/10; F16M 11/04

(52) U.S. Cl. CPC F16M 11/10; F16M 11/043; F16M 2200/08; F16M 2200/06

(57) ABSTRACT

A support stand includes a base and a support bracket. The support bracket has a first side and a second side opposite to each other. The first side is rotatably connected to the base. The support bracket further has a slot extending from the second side toward the first side.

### CROSS-REFERENCE TO RELATED APPLICATION

This application claims priority to Taiwan Application Serial Number 110132705, filed Sep. 2, 2021, which is herein incorporated by reference.

### BACKGROUND

### Technical Field

The present disclosure relates to a support stand, and more particularly, to the support stand for supporting electronic devices.

### Description of Related Art

With the rapid development, tablet computers bring a lot of convenience in work, life and study. Due to the different needs of users, different usage scenarios are also derived. In addition, as the opportunity to work or attend classes from home increases, so does the time spent on tablet computers.

However, tablet computers have a certain weight. Continued hand-held operation can cause hand injury to the user. There are many protective cases and supports on the market, which only provide protection and basic support (such as for travel), and are not designed for long-term fixed-point use (such as home or business). Therefore, these designs cannot be easily adjusted by users to meet different usage situations.

Accordingly, how to provide a support stand to solve the aforementioned problems becomes an important issue to be solved by those in the industry.

### SUMMARY

An aspect of the disclosure is to provide a support stand that can efficiently solve the aforementioned problems.

According to an embodiment of the disclosure, a support stand includes a base and a support bracket. The support bracket has a first side and a second side opposite to each other. The first side is rotatably connected to the base. The support bracket further has a slot extending from the second side toward the first side.

In an embodiment of the disclosure, the support bracket further has a side surface. The slot further extends to the side surface.

In an embodiment of the disclosure, the slot has a main opening and a side opening connected to each other. The main opening is located on the second side. The side opening is located on the side surface.

In an embodiment of the disclosure, the slot has two inner walls opposite to each other. The support bracket further has a through hole. The through hole is communicated to one of the two inner walls. The support stand further includes an abutting member. The abutting member is movably engaged with the through hole and configured to partially protrude into the slot via the through hole.

In an embodiment of the disclosure, the abutting member is screwed with an inner edge of the through hole.

In an embodiment of the disclosure, the abutting member includes an elastic pad. The elastic pad is located at a side of the abutting member facing another of the two inner walls.

In an embodiment of the disclosure, the support stand further includes a lever. The lever is located outside the slot. An end of the lever is connected to the abutting member.

In an embodiment of the disclosure, the support bracket further has a side surface. The slot has a side opening located on the side surface. When the abutting member partially protrudes into the slot, another end of the lever and the side opening are facing each other in a direction perpendicular to the side surface.

In an embodiment of the disclosure, when the another end of the lever abuts against the side surface, the abutting member is located outside the slot.

In an embodiment of the disclosure, the slot has two inner walls opposite to each other. The inner walls have a plurality of recessed portions. The support stand further includes a plurality of abutting members. The abutting members are respectively accommodated in the recessed portions and partially protrude into the slot.

In an embodiment of the disclosure, the support bracket further has two side surfaces opposite to each other. Two ends of each of the recessed portions are respectively located on the two side surfaces.

In an embodiment of the disclosure, the abutting members are elastic strips.

In an embodiment of the disclosure, the slot has a side opening located on one of the two side surfaces. The support stand further includes a stopping member. The stopping member includes an insertion portion and a stopping portion. The insertion portion inserts into an end of one of the recessed portions located on the side opening. The stopping portion is connected to the insertion portion and bent relative to the insertion portion. The stopping portion and the side opening are facing each other in a direction perpendicular to the side surface.

In an embodiment of the disclosure, the support bracket further has a through hole. The through hole is communicated to the one of the recessed portions. The support stand further includes a pin. The pin inserts into and is engaged with the insertion portion.

In an embodiment of the disclosure, a bottom surface of the base has at least one hanging hole. The bottom surface is located on a side of the base away from the support bracket.

In an embodiment of the disclosure, the slot has two inner walls opposite to each other. An included angle between one of the two inner walls and the bottom surface is less than 90 degrees.

Accordingly, in the support stand of the present disclosure, the support stand of the present disclosure is suitable for an electronic device (such as a tablet computer) having a main body and a back cover that can be turned relative to the main body. In the support stand, the support bracket can adjust the rotation angle relative to the base. Therefore, after the back cover of the electronic device is inserted into the slot of the support bracket, the viewing angle and height of the electronic device can be adjusted by the rotation between the support bracket and the base and the rotation between the main body and the back cover of the electronic device. By disposing the abutting member on the support bracket, the back cover of the electronic device can be tightly fixed in the slot. By having the slot with the main opening and the side opening connected to each other, the support stand can be adapted to electronic devices of various sizes. By disposing a stopping member facing the side opening on the support bracket, the electronic device can be effectively prevented from being separated from the support bracket through the side opening.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a side view of a support stand and an electronic device according to an embodiment of the present disclosure;

FIG. 1B is another side view of the support stand and the electronic device in FIG. 1A;

FIG. 2 is a partial perspective view of a support stand and an electronic device according to another embodiment of the present disclosure;

FIG. 3A is a partial cross-sectional view of the support stand and the electronic device in FIG. 2;

FIG. 3B is another partial cross-sectional view of the support stand and the electronic device in FIG. 2;

FIG. 4 is another partial perspective view of the support stand and the electronic device in FIG. 2;

FIG. 5 is a partial side view of a support stand and an electronic device according to another embodiment of the present disclosure;

FIG. 6A is a partial perspective view of the support stand and the electronic device in FIG. 5;

FIG. 6B is another partial perspective view of the support stand and the electronic device in FIG. 5;

FIG. 7 is another perspective view of the support stand and the electronic device in FIG. 1A; and

FIG. 8 is a schematic diagram illustrating an application of the support stand and the electronic device in FIG. 1A.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts. However, specific structural and functional details disclosed herein are merely representative for purposes of describing example embodiments, and thus may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the disclosure.

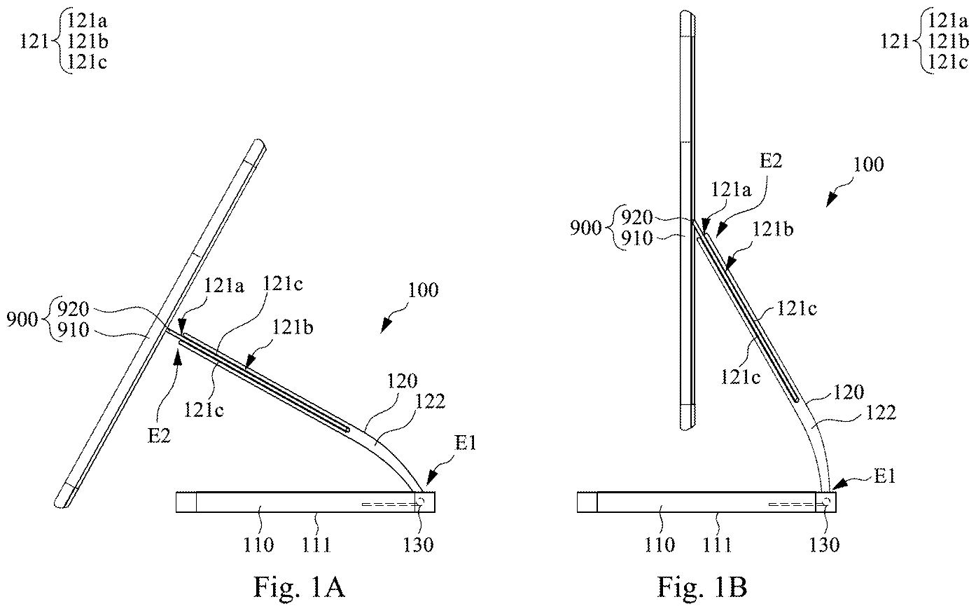

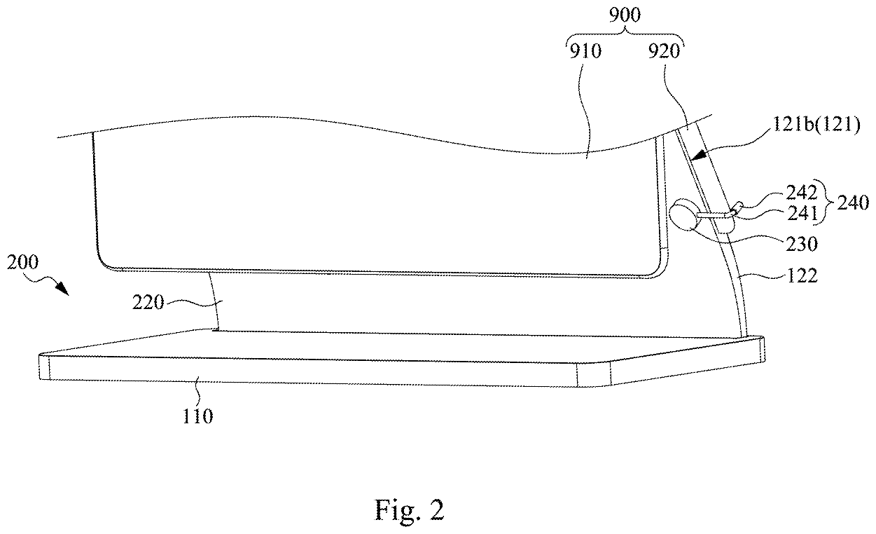

Reference is made to FIGS. 1A and 1B. FIG. 1A is a side view of a support stand 100 and an electronic device 900 according to an embodiment of the present disclosure. FIG. 1B is another side view of the support stand 100 and the electronic device 900 in FIG. 1A. As shown in FIGS. 1A and 1B, in the present embodiment, the support stand 100 is for supporting the electronic device 900 having a back cover 920, in which the back cover 920 can turn relative to a main body 910 of the electronic device 900. The support stand 100 includes a base 110 and a support bracket 120. The support bracket 120 has a first side E1 and a second side E2 opposite to each other. The first side E1 is rotatably connected to the base 110. The support bracket 120 further has a slot 121. The slot 121 extends from the second side E2 toward the first side E1. A virtual rotation axis can be defined by the rotation between the first side E1 and the base 110. The profile of the cross-section of the support bracket 120 on any plane perpendicular to the virtual rotation axis is substantially Y-shaped.

In some embodiments, as shown in FIGS. 1A and 1B, the base 110 has an installation groove (not shown), and the first side E1 of the support bracket 120 is inserted into the installation groove and connected to the base 110 via a hinge 130 (indicated by a dotted line in the figures). The rotation angle of the support bracket 120 relative to the base 110 can be limited by retaining the position of the support bracket 120 by the two opposite edges of the aforementioned installation groove. For example, when the support bracket 120 rotates relative to the base 110 to abut against an edge of the installation groove, it is in the state shown in FIG. 1A; and when the support bracket 120 rotates relative to the base 110 to abut against the other edge of the installation groove, it is in the state shown in FIG. 1B.

With the foregoing structural configurations, after the back cover 920 of the electronic device 900 is inserted into the slot 121 of the support bracket 120, the user can adjust the viewing angle and height of the electronic device 900 through the rotation between the support bracket 120 and the base 110 and the rotation between the main body 910 and the back cover 920 of the electronic device 900. The back cover 920 of the electronic device 900 is inserted into the slot 121 of the support bracket 120 along the longitudinal direction of the support bracket 120 (i.e., from the second side E2 to the first side E1).

As shown in FIGS. 1A and 1B, in the present embodiment, the support bracket 120 further has a side surface 122. The slot 121 further extends to the side surface 122. In detail, the slot 121 has a main opening 121a and a side opening 121b connected to each other. The main opening 121a is located on the second side E2. The side opening 121b is located on the side surface 122. The side surface 122 provided with the side opening 121b is substantially Y-shaped. In this way, the slot 121 can allow the back cover 920 with a wider width than that of the slot 121 to insert thereto, so that the support stand 100 of the present embodiment is suitable for electronic devices 900 of various sizes.

In the present embodiment, the slot 121 has two inner walls 121c opposite to each other. After the back cover 920 of the electronic device 900 is inserted into the slot 121, it is retained between the two inner walls 121c. In some embodiments, the two inner walls 121c are parallel to each other, but the present disclosure is not limited in this regard. The slot 121 forms an accommodating space that extends along the longitudinal direction of the support bracket 120 (from the second side E2 to the first side E1) and along the lateral direction of the support bracket 120 (from one side surface 122 to the opposite side surface 122). After the back cover 920 of the electronic device 900 is inserted into the slot 121 of the support bracket 120, the rotation axis between the support bracket 120 and the base 110 can be substantially parallel to the rotation axis between the main body 910 and the back cover 920 of the electronic device 900. The slot 121 forms the two inner walls 121c substantially flat.

In some embodiments, the slot 121 may extend to the two opposite side surfaces 122 of the support bracket 120. That is, each of the two opposite side surfaces 122 of the support bracket 120 has a side opening 121b connected to the main opening 121a. Therefore, when the width of the back cover 920 of the electronic device 900 is larger than the width of the slot 121, the user can make two sides of the back cover 920 respectively protrude from the two side openings 121b at substantially the same distance. This not only enables the combination of the electronic device 900 and the support stand 100 to present a symmetrical visual aesthetic, but also prevents the electronic device 900 from biasing the support stand 100.

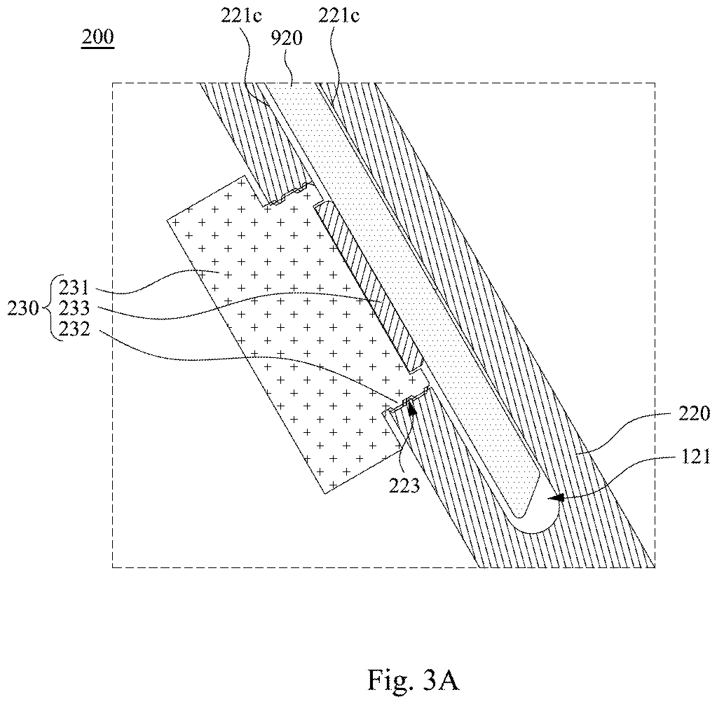

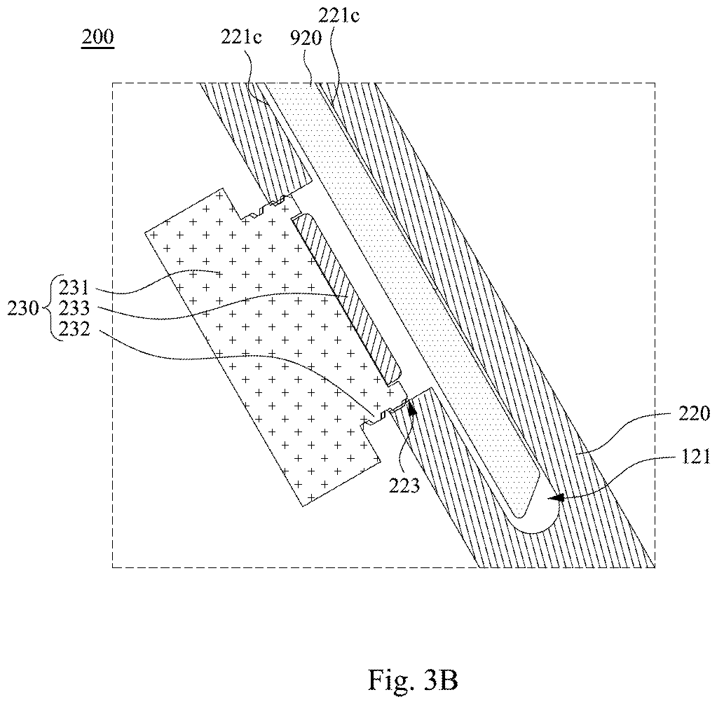

Reference is made to FIGS. 2 and 3A. FIG. 2 is a partial perspective view of a support stand 200 and an electronic device 900 according to another embodiment of the present disclosure. FIG. 3A is a partial cross-sectional view of the support stand 200 and the electronic device 900 in FIG. 2. Compared with the embodiment shown in FIG. 1A, the support stand 200 of the present embodiment provides a modified support bracket 220. Specifically, the support bracket 220 in the present embodiment further has a through hole 223. The through hole 223 is communicated with one of the inner walls 221c of the slot 121. The support stand 200 further includes an abutting member 230. The abutting member 230 is movably engaged with the through hole 223 and is configured to partially protrude into the slot 121 through the through hole 223. In this way, the abutting member 230 partially protruding into the slot 121 can tightly fix the back cover 920 of the electronic device 900 in the slot 121.

In some embodiments, as shown in FIG. 3A, the abutting member 230 is screwed with the inner edge of the through hole 223. Specifically, the inner edge of the through hole 223 has an internal thread. The abutting member 230 includes a head portion 231 and a threaded portion 232 connected together, and the head portion 231 is located outside the through hole 223. The threaded portion 232 has an external thread that is engaged with the internal thread. The radial width of the head portion 231 is larger than the radial width of the threaded portion 232. In this way, the abutting member 230 can be prevented from protruding too deep into the slot 121 to squeeze the back cover 920.

In addition, reference is made to FIG. 3B. FIG. 3B is another partial cross-sectional view of the support stand 200 and the electronic device 900 in FIG. 2. As shown in FIG. 3B, by rotating the abutting member 230, the portion of the abutting member 230 originally protruding into the slot 121 can be retracted into the through hole 223 and located outside the slot 121. In this way, the back cover 920 of the electronic device 900 can be released by the abutting member 230 and can be freely pulled out from the slot 121.

In the present embodiment, the abutting member 230 further includes an elastic pad 233. The elastic pad 233 is located on the side of the abutting member 230 facing the other inner wall 221c. By contacting the elastic pad 233 with the back cover 920 of the electronic device 900, the wear of the back cover 920 caused by the abutting member 230 can be avoided.

In some embodiments, the material of the elastic pad 233 includes rubber, but the present disclosure is not limited in this regard.

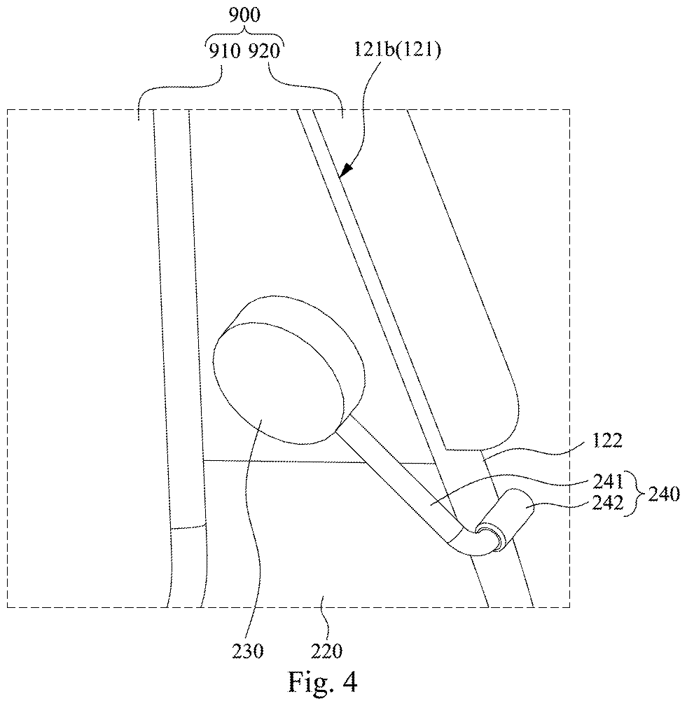

Reference is made to FIG. 4. FIG. 4 is another partial perspective view of the support stand 200 and the electronic device 900 in FIG. 2. As shown in FIGS. 2 to 4, in the present embodiment, the support stand 200 further includes a lever 240. The lever 240 is located outside the slot 121. The lever 240 includes a body 241. One end of the body 241 is connected to the abutting member 230. In this way, the user can rotate the abutting member 230 by turning the lever 240.

As shown in FIGS. 2 and 3A, when the abutting member 230 partially protrudes into the slot 121, another end of the body 241 of the lever 240 is facing the side opening 121b in a direction perpendicular to the side surface 122. In this way, the another end of the lever 240 can retain the side of the back cover 920, thereby preventing the back cover 920 from falling out of the side opening 121b of the slot 121.

As shown in FIGS. 3B and 4, when the user toggles the lever 240 and rotates the abutting member 230 until the another end of the lever 240 abuts against the side surface 122, the abutting member 230 is located outside the slot 121. In this way, the back cover 920 of the electronic device 900 can be released by the abutting member 230.

As shown in FIGS. 2 and 4, the lever 240 further includes a protective cover 242. The protective cover 242 is sleeved on the another end of the body 241 of the lever 240. The protective cover 242 not only can improve the user's comfort when grasping, but also prevent the lever 240 from causing wear on the side surface 122 of the support bracket 220 or the back cover 920 of the electronic device 900.

In some embodiments, the lever 240 may be eliminated, and the user may directly rotate the abutting member 230 with fingers, which can also achieve the purpose of making the abutting member 230 abut against and release the back cover 920 of the electronic device 900. In some embodiments, in order to facilitate the user to rotate the abutting member 230, grooves that are annularly arranged and parallel may be disposed on the periphery of the abutting member 230.

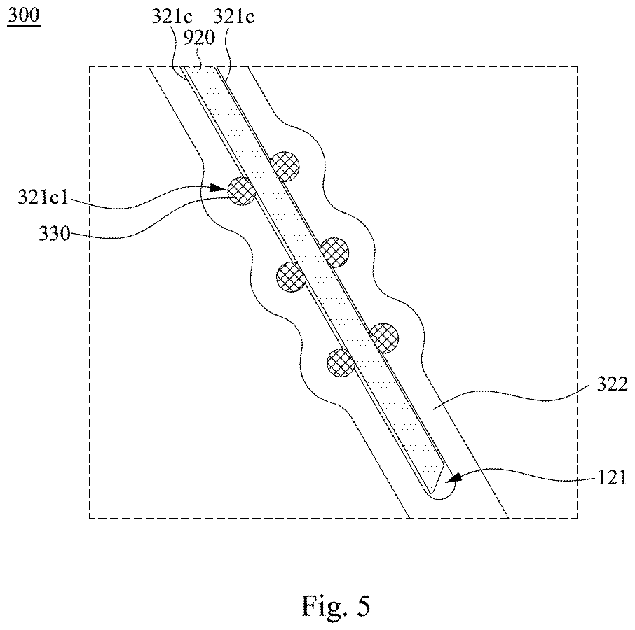

Reference is made to FIG. 5. FIG. 5 is a partial side view of a support stand 300 and an electronic device 900 according to another embodiment of the present disclosure. Compared with the embodiment shown in FIG. 1A, the support stand 300 of the present embodiment provides a modified support bracket 320. Specifically, the support bracket 320 of the present embodiment is provided with a plurality of recessed portions 321c1 on the two inner walls 321c of the slot 121. The support stand 300 further includes a plurality of abutting members 330. The abutting members 330 are respectively accommodated in the recessed portions 321c1 and partially protrude into the slot 121. In this way, the abutting members 330 partially protruding into the slot 121 can tightly fix the back cover 920 of the electronic device 900 in the slot 121.

In some embodiments, two ends of each of the recessed portions 321c1 are located on two opposite side surfaces 322 of the support bracket 320, respectively. That is, each of the recessed portions 321c1 may be an elongated groove. Correspondingly, the abutting members 330 can be elongated, so as to increase the contact areas with the back cover 920.

In some embodiments, the abutting members 330 are elastic strips. In this way, when the abutting members 330 are in contact with the back cover 920 of the electronic device 900, the wear of the back cover 920 caused by the abutting members 330 can be avoided.

In some embodiments, the profile of the cross-section of each of the recessed portions 321c1 on a plane parallel to the side surface 322 is C-shaped, and the profiles of the cross-sections of the abutting members 330 on the plane parallel to the side surface 322 are substantially circular, so as to prevent the abutting members 330 inserted into the recessed portions 321c1 from easily detaching from the recessed portions 321c1, but the present disclosure is not limited in this regard.

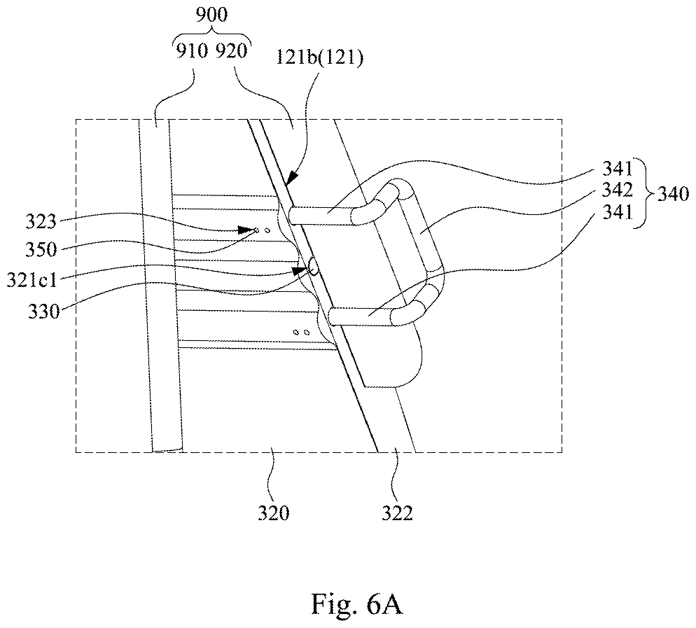

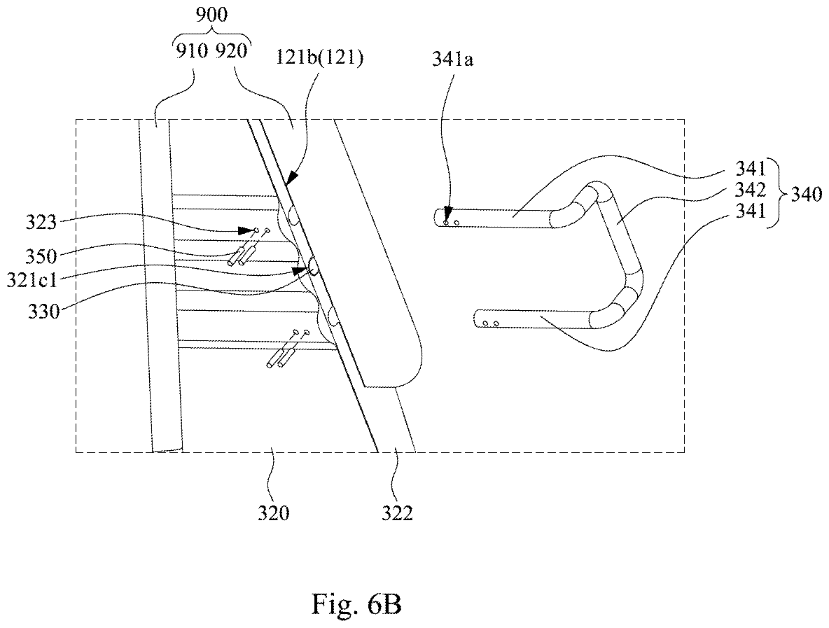

Reference is made to FIGS. 6A and 6B. FIG. 6A is a partial perspective view of the support stand 300 and the electronic device 900 in FIG. 5. FIG. 6B is another partial perspective view of the support stand 300 and the electronic device 900 in FIG. 5. As shown in FIGS. 6A and 6B, in the present embodiment, the support stand 300 further includes a stopping member 340. The stopping member 340 includes two insertion portions 341 and a stopping portion 342. The two insertion portions 341 are respectively inserted into ends of two recessed portions 321c1 located on the same side surface 322. The stopping portion 342 is connected between the two insertion portions 341 and is bent relative to the insertion portions 341. The stopping portion 342 is facing the side opening 121b in a direction perpendicular to the side surface 322. In this way, the stopping portion 342 can retain the side of the back cover 920, thereby preventing the back cover 920 from falling out from the side opening 121b of the slot 121.

In addition, the support bracket 320 further has a plurality of through holes 323. Each of the through holes 323 is communicated with one of the recessed portions 321c1 into which the insertion portions 341 insert. The support stand 300 further includes a pin 350. The insertion portions 341 have insertion holes 341a into which the pin 350 inserts. In this way, the user can insert the two insertion portions 341 into the two recessed portions 321c1 respectively, and then insert the pin 350 into one of the through holes 323 and the corresponding insertion hole 341a in sequence, such that the stopping member 340 can be fixed on the support bracket 320.

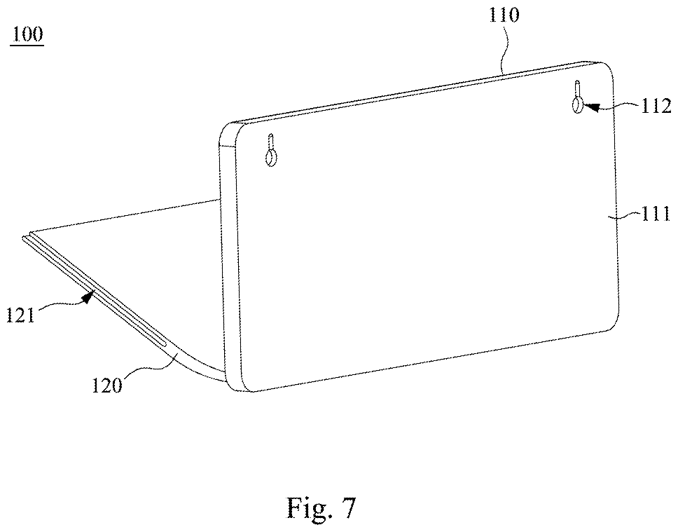

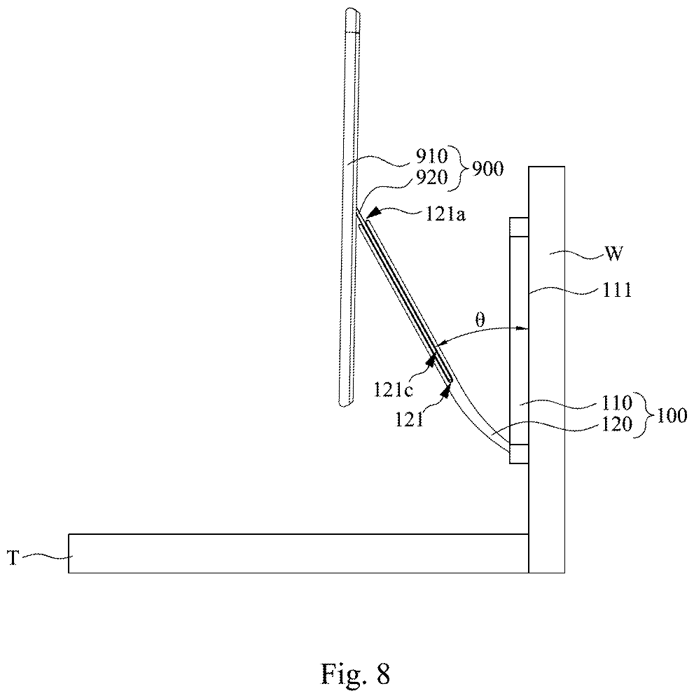

Reference is made to FIGS. 7 and 8. FIG. 7 is another perspective view of the support stand 100 and the electronic device 900 in FIG. 1A. FIG. 8 is a schematic diagram illustrating an application of the support stand 100 and the electronic device 900 in FIG. 1A. As shown in FIGS. 7 and 8, in the present embodiment, the bottom surface 111 of the base 110 has a plurality of hanging holes 112. The bottom surface 111 is located on a side of the base 110 away from the support bracket 120. In this way, the base 110 can be hung on the wall W by using the hanging holes 112 to fasten the hooks on the wall W, thereby making the support stand 100 a wall-mounted bracket. In addition, by making the included angle θ between any of the inner walls 121c of the slot 121 and the bottom surface 111 less than 90 degrees when the support bracket 120 is at the maximum rotation angle relative to the base 110 and making the main opening 121a of the slot 121 substantially face upward, the electronic device 900 can be prevented from falling out due to the back cover 920 falling out of the slot 121. In the case where the support stand 100 of the present embodiment is applied as a wall-mounted stand, the space between the table T and the electronic device 900 can be vacated for other applications.

According to the foregoing recitations of the embodiments of the disclosure, it can be seen that in the support stand, the support bracket can adjust the rotation angle relative to the base. Therefore, after the back cover of the electronic device is inserted into the slot of the support bracket, the viewing angle and height of the electronic device can be adjusted by the rotation between the support bracket and the base and the rotation between the main body and the back cover of the electronic device. By disposing the abutting member on the support bracket, the back cover of the electronic device can be tightly fixed in the slot. By having the slot with the main opening and the side opening connected to each other, the support stand can be adapted to electronic devices of various sizes. By disposing a stopping member facing the side opening on the support bracket, the electronic device can be effectively prevented from being separated from the support bracket through the side opening.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A support stand, comprising:
a base; and
a support bracket having a first side and a second side opposite to each other, the first side being rotatably connected to the base, the support bracket further having a slot extending from the second side toward the first side.

2. The support stand of claim 1, wherein the support bracket further has a side surface, and the slot further extends to the side surface.

3. The support stand of claim 2, wherein the slot has a main opening and a side opening connected to each other, the main opening is located on the second side, and the side opening is located on the side surface.

4. The support stand of claim 1, wherein the slot has two inner walls opposite to each other, the support bracket further has a through hole, the through hole is communicated to one of the two inner walls, and the support stand further comprises:
an abutting member movably engaged with the through hole and configured to partially protrude into the slot via the through hole.

5. The support stand of claim 4, wherein the abutting member is screwed with an inner edge of the through hole.

6. The support stand of claim 4, wherein the abutting member comprises an elastic pad, and the elastic pad is located at a side of the abutting member facing another of the two inner walls.

7. The support stand of claim 4, further comprising:
a lever located outside the slot, an end of the lever being connected to the abutting member.

8. The support stand of claim 7, wherein the support bracket further has a side surface, the slot has a side opening located on the side surface, and when the abutting member partially protrudes into the slot, another end of the lever and the side opening are facing each other in a direction perpendicular to the side surface.

9. The support stand of claim 8, wherein when the another end of the lever abuts against the side surface, the abutting member is located outside the slot.

10. The support stand of claim 1, wherein the slot has two inner walls opposite to each other, the inner walls have a plurality of recessed portions, and the support stand further comprises:
a plurality of abutting members respectively accommodated in the recessed portions and partially protruding into the slot.

11. The support stand of claim 10, wherein the support bracket further has two side surfaces opposite to each other, and two ends of each of the recessed portions are respectively located on the two side surfaces.

12. The support stand of claim 11, wherein the abutting members are elastic strips.

13. The support stand of claim 11, wherein the slot has a side opening located on one of the two side surfaces, the support stand further comprises a stopping member, and the stopping member comprises:
an insertion portion inserting into an end of one of the recessed portions located on the side opening; and
a stopping portion connected to the insertion portion and bent relative to the insertion portion, wherein the stopping portion and the side opening are facing each other in a direction perpendicular to the side surfaces.

14. The support stand of claim 13, wherein the support bracket further has a through hole, the through hole is communicated to the one of the recessed portions, and the support stand further comprises:
a pin inserting into and engaged with the insertion portion.

15. The support stand of claim 1, wherein a bottom surface of the base has at least one hanging hole, and the bottom surface is located on a side of the base away from the support bracket.

16. The support stand of claim 15, wherein the slot has two inner walls opposite to each other, and an included angle between one of the two inner walls and the bottom surface is less than 90 degrees.
